(19) United States
(12) Patent Application Publication
(10) Pub. No.: US 2002/0130228 A1
(43) Pub. Date: Sep. 19, 2002

(54) Foot stand structure of an adjustable computer desk

(76) Inventor: Lin-Ho Liu, Yung-Ho City (TW)

Correspondence Address: Lin-Ho LIU, P.O. Box No.6-57, Taipei Hsien 235, Chung-Ho-City, TW

(21) Appl. No.: 09/810,612

(22) Filed: Mar. 19, 2001

(51) Int. Cl. F16M 11/00

(52) U.S. Cl. 248/161

(57) ABSTRACT

The invention herein relates to a foot stand structure of an adjustable computer desk, more especially, a foot stand structure of an adjustable computer capable of performing high efficient adjustment for desk body such as those used for placing the computer on it during operation; the structure not only efficiently and precisely adjusts the height of the computer desk, but also surpasses the inconvenience caused by the necessary disassembly of the foot stand of the prior computer desk for adjusting the height; the entire structure of the invention herein comprises of the adjusting frame seats, a link shaft rod, a set of inner rods with helical teeth and the matching threaded bushes, a set of smooth inner rods and bushes, a foot stand and an external rotating handle bar; furthermore, through the movement of the adjusting frame seats, the invention herein can efficiently adjust the foot stand of the computer desk, the computer desk as well as the computer to a satisfactory height for the user to achieve the efficient creativity of the entire disposition.

### BACKGROUND OF THE INVENTION

1) Field of the Invention

The invention herein relates to a foot stand structure of an adjustable computer desk, more especially, a foot stand structure of an adjustable computer capable of performing high efficient adjustment for desk body such as those used for placing the computer on it during operation; wherein the adjusting frame seats, a link shaft rod, a set of inner rods with helical teeth and the matching threaded bushes, a set of smooth inner rods and bushes, and a foot stand are assembled with an external rotating handle bar to form the entire and related structure of the invention herein.

2) Description of the Prior Art

The familiar adjustable structure of the foot stand of the conventional computer desk has the inner rod and the outer bush with interlocking holes in the same sizes. After the interlocking holes are pushed against each other, the tenons will be interlocked. However, using this kind of structure to adjust the height of the computer desk still has the shortcomings of having to remove the heavy objects on the computer desk or being unable to precisely adjust the computer desk.

### SUMMARY OF THE INVENTION

Therefore, the inventor of the invention herein, after many tests and experiments, has culminated in a perfect innovative patent. To enable a further understanding of the features and the innovation of the invention herein, the brief description of the drawings below is followed by the detailed description of the preferred embodiment.

### BRIEF DESCRIPTION OF THE DRAWINGS

FIG. 1 is a pictorial and isometric drawing of the external view of the desk feet of the invention herein in preferred embodiment.

FIG. 2 is a drawing of the side view and the cross section of the connection between the smooth inner rod and bush of the invention herein.

FIG. 3 is a drawing of the side view and the cross section of the mesh between the inner rod with helical teeth and the threaded bush of the invention herein.

FIG. 4 is an isometric and perspective drawing of the external view of the adjusting frame seat of the invention herein.

FIG. 5 is a drawing of the side view of the bevel gears of the invention herein.

FIG. 6 is a drawing of the movement state of the bevel gears of the invention herein.

FIG. 7 is a drawing of the invention herein in embodiment.

### DETAILED DESCRIPTION OF THE PREFERRED EMBODIMENTS

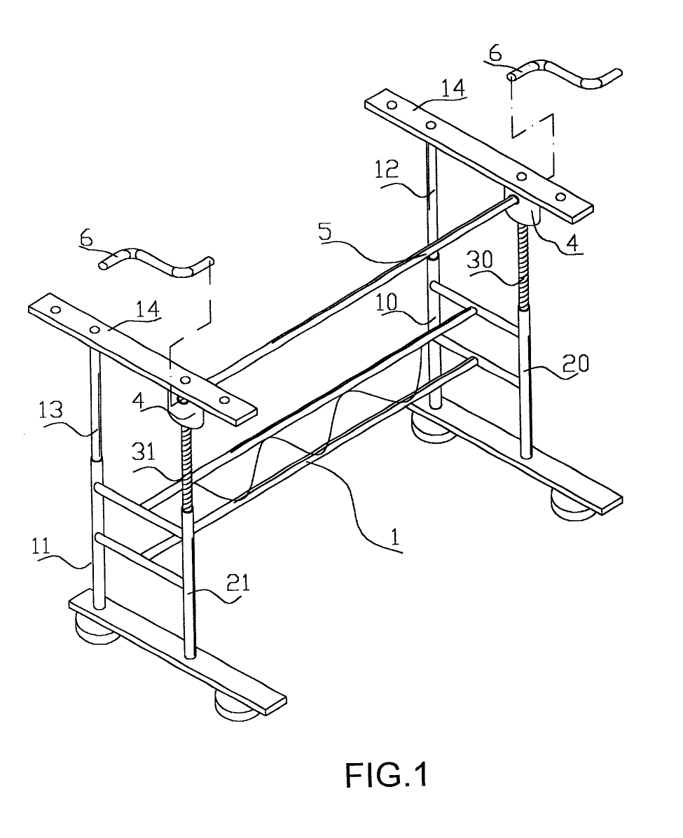

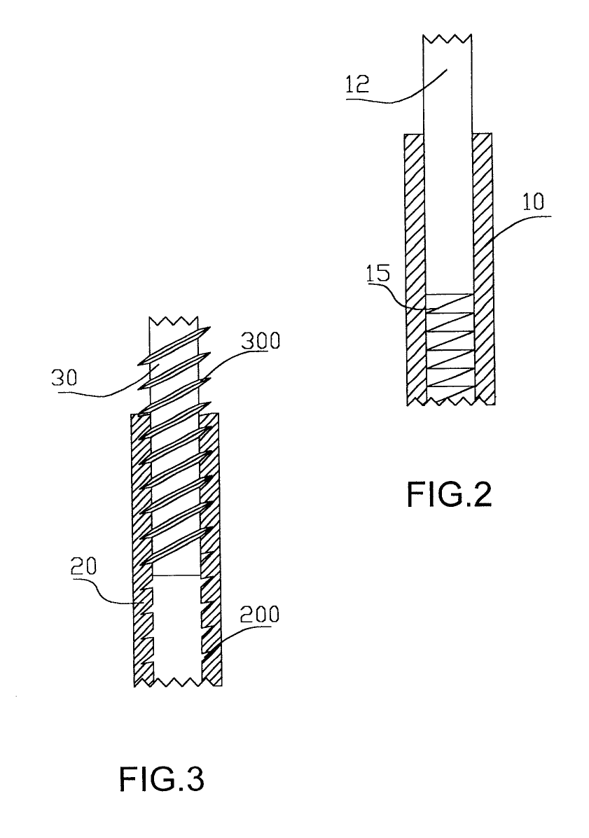

Referring to FIGS. 1, 2 and 3, the invention herein comprising of a foot stand (1) mounted by a set of threaded bushes (20, 21) thereon; the threaded bushes (20, 21) disposed by a set of inner rods with helical teeth (30, 31) capable of extending just and helically inside the threaded bushes (20, 21), the inner rods with helical teeth (30, 31) extending respectively upwards and inserted into the inner space of an adjusting frame seat (4), a link shaft rod (5) connecting the link between the two transverse adjusting frame seats (4), and an external rotating handle bar (6); wherein, the main function of the foot stand (1) is to fix the foot stand structure of the computer desk; in addition to having a set of threaded bushes (20, 21) and a set of inner rods with helical teeth (30, 31) capable of extending just and helically inside the threaded bushes (20, 21) on one side surface of the longitudinal sides of the foot stand (1), there is another set of relative and smooth bushes (10, 11) and inner rods (12, 13) on the other side surface of the longitudinal sides; a transverse extension rod (14) connects the inner rods with helical teeth (30, 31) with the adjusting frame seats (4) thereon and the smooth inner rods (12, 13); a powerful spring (15) is mounted on the bottom portion inside the smooth bushes (10, 11) for increasing the supporting force of the smooth inner rods (12, 13) relative to the desk body; the threads (200) are formed on the inner side surfaces of the threaded bushes (20, 21); the sizes and the forms of the threads (200) just mesh the helical teeth (300) on the column surfaces of the inner rods with helical teeth (30, 31) allowing the inner rods with helical teeth (30, 31) to freely extend inside the threaded bushes (20, 21); the rotating handle bar (6) can be inserted in any of the adjusting frame seats (4) for operating based on the specific need of the computer desk user.

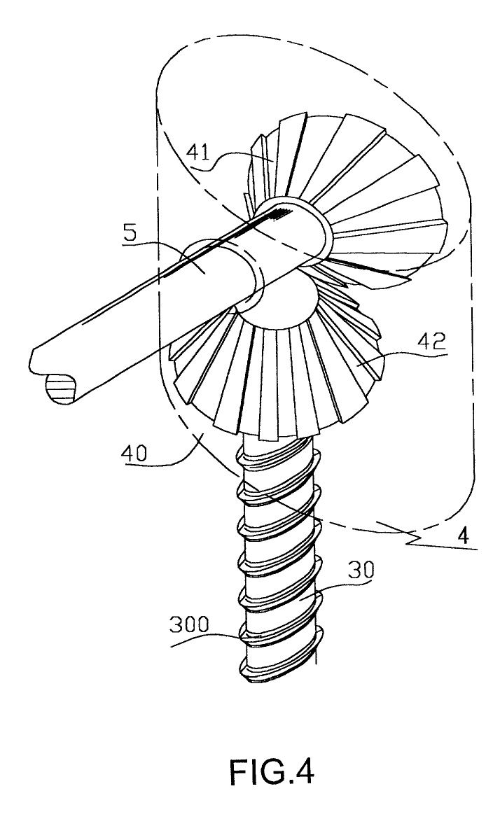

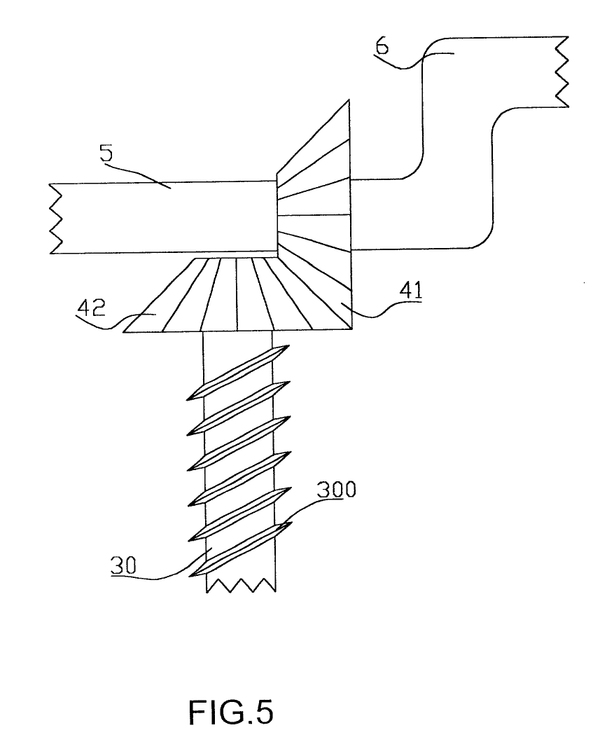

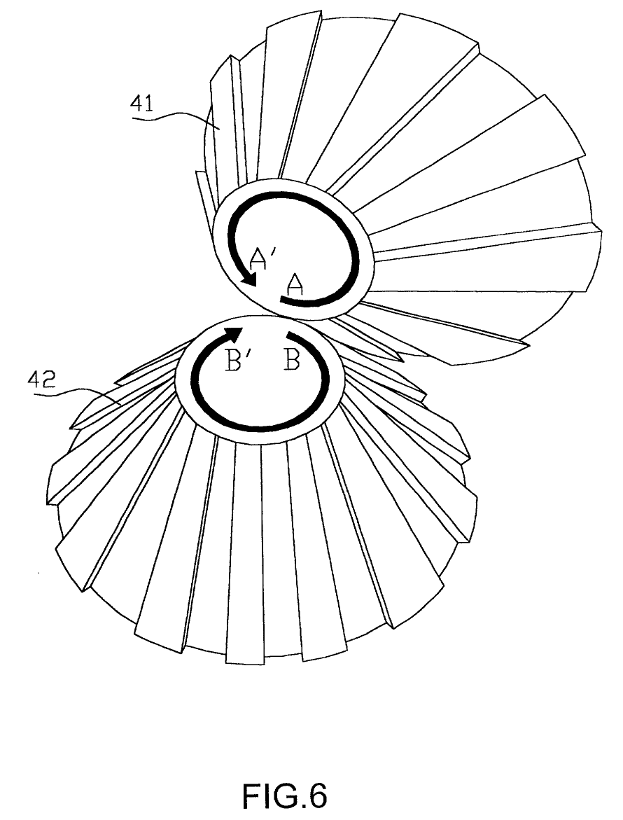

Referring to FIGS. 4 and 5, the structure of the adjusting frame seat (4) of the invention herein comprises of a shell body (40), one vertical and one horizontal bevel gears (41, 42) in mesh and mounted therein; the central portion of the vertical bevel gear (41) is penetrated to respectively connect with both the link shaft rod (5) in the front and at the rear portions and the external rotating handle bar (6) approximately at the central area of the penetrated portion; the link shaft rod (5) connects the central portion of another vertical bevel gear (41) disposed in the adjusting frame seat (4) on the top end of the inner rod with helical teeth (31) for producing the link movement; the horizontal bevel gear (42) extends from the inner portion to connect with the inner rod with helical teeth (30); the extended and connected inner rod with helical teeth (30) go downwards and through the shell body (40) to be threaded to the inner end of the threaded bushes (20).

Referring again from FIGS. 1 to 7, when trying to lower the height of the computer desk surface (7), one only needs to insert the rotating handle bar (6) to any of the adjusting frame seats (4) to connect with the vertical bevel gear (41); through the rotation of the rotating handle bar (6), the vertical bevel gear (41) will rotate to the same direction (as shown in FIG. 5); when the vertical bevel gear (41) rotates in the direction of A-A′, at the same time, it will drive the link shaft rod (5) and another vertical bevel gear (41) disposed in the adjusting frame seat (4) on the top end of the inner rod with helical teeth (31) to rotate to the same direction of A-A′; at the mean time, the vertical bevel gear (41) will drive the two horizontal bevel gears (42) to rotate in the direction B-B′ and link the inner rods with helical teeth (30, 31) to thread downwards into the threaded bushes (20, 21); furthermore, through the transverse extension rod (14) guiding the smooth inner rods (12, 13) to slide into the smooth bushes (10, 11) at the same time, the computer desk surface (7) and the objects on the desk (8) can be adjusted lower; when the user tries to elevate the height of the computer desk surface, he only has to rotate the rotating handle bar (6) toward the reverse direction.

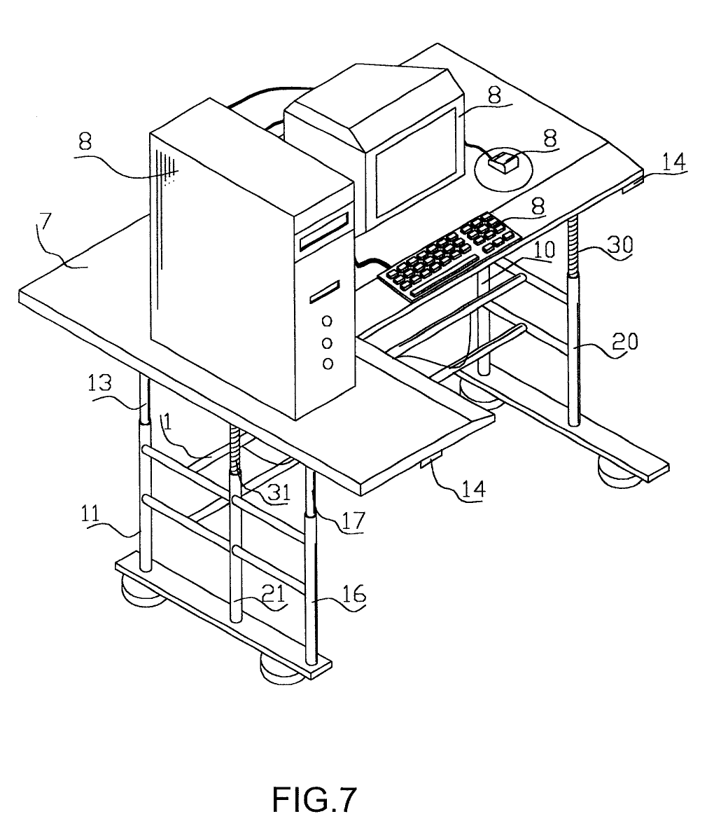

Referring to FIG. 7 again, if the shape of the computer desk surface (7) will be changed into an L-shape or other shapes, the length of the transverse extension rod (14) can be extended and another set of a smooth bush (16), a smooth inner rod (17) and a powerful spring (15) can be added based on the need to increase the supporting force and the function of being easy to be elevated or lowered.

In summation of the foregoing sections, the invention herein is definitely an improved invention of progress, fully complies with all new patent application requirements and is hereby submitted to the patent bureau for review and the granting of the commensurate patent rights.

1. The invention herein relates to a foot stand structure of an adjustable computer desk, mainly comprising of a foot stand mounted by a set of threaded bushes thereon, the threaded bushes disposed by a set of inner rods with helical teeth capable of extending just and helically inside the threaded bushes, the inner rods with helical teeth extending respectively upwards and inserted into the inner space of an adjusting frame seat, a link shaft rod connecting the link between the two transverse adjusting frame seats, and an external rotating handle bar, is characterized that:
the foot stand has a set of threaded bushes and a set of inner rods with helical teeth capable of extending just and helically inside the threaded bushes mounted on one side surface of the longitudinal sides of the foot stand, another set of relative and smooth bushes and inner rods mounted on the other side surface of the longitudinal sides, a transverse extension rod connecting both the inner rods with helical teeth with the adjusting frame seats thereon and the smooth inner rods, and a powerful spring mounted on the bottom portion inside the smooth bushes;
the threaded bushes have a set of inner rods with helical teeth capable of extending just and helically inside the threaded bushes; the threads are formed on the inner side surfaces of the threaded bushes; the sizes and the forms of the helical teeth on the column surfaces of the inner rods with helical teeth just match with the threaded threads;
the adjusting frame seat comprises of a shell body, one vertical and one horizontal bevel gears in mesh and mounted therein; the central portion of the vertical bevel gear is penetrated to respectively connect with both the link shaft rod in the front and at the rear portions and the external rotating handle bar approximately at the central area of the penetrated portion; the link shaft rod connects the central portion of another vertical bevel gear disposed in the adjusting frame seat on the top end of the inner rod with helical teeth; the horizontal bevel gear extends from the inner portion to connect with the inner rod with helical teeth; the extended and connected inner rod with helical teeth go downwards and through the shell body to be threaded to the inner end of the threaded bushes.

2. As mentioned in claim 1 of the foot stand structure of an adjustable computer desk, wherein the number of the set of threaded bushes, the inner rod with helical teeth, the link shaft rod and the adjusting frame seat can be increased or reduced according to the specific need.

3. As mentioned in claim 1 of the foot stand structure of an adjustable computer desk, wherein the length of the transverse extension rod can be changed according to the need.

4. As mentioned in claim 1 of the foot stand structure of an adjustable computer desk, wherein the rotating handle bar can be inserted to any of the adjusting frame seat according to the specific need.
